(19) United States
(12) Patent Application Publication
(10) Pub. No.: US 2006/0243319 A1
(43) Pub. Date: Nov. 2, 2006

(54) Clustered solar-energy conversion array and method therefor

(75) Inventors: Stephen Kusek, Owens Cross Roads, AL (US); Herbert T. Hayden, Tempe, AZ (US)

Correspondence Address: MESCHKOW & GRESHAM, P.L.C., 5727 NORTH SEVENTH STREET, SUITE 409, PHOENIX, AZ, 85014, US

(73) Assignee: Arizona Public Service Company

(21) Appl. No.: 11/118,006

(22) Filed: Apr. 29, 2005

(51) Int. Cl. H02N 6/00

(52) U.S. Cl. 136/246

(57) ABSTRACT

A solar-energy conversion (SEC) array (24) and method of operation are presented. The array (24) has an aim direction (48) substantially coincident with a solar direction (50) when the array (24) is operational. The array (24) is made up of an array-support structure (26), and a plurality of SEC clusters (28). Each cluster (28) is made up of a number of SEC units (44) and a single cell-support structure (32). Each SEC unit (44) is made up of a concave mirror (30) coupled to the array-support structure (26), and a cell assembly (34). The cell assembly (34) is made up of a cell housing (68) containing an SEC cell (72), and a passive heat-extraction unit (70) thermally coupled to the cell (72) and configured to extract and dissipate heat. The cell-support structure (32) is made up of a support column (56) coupled to the array-support structure (26), and individual support arms (60) coupling each of cell assemblies (34) to the support column (56).

### TECHNICAL FIELD OF THE INVENTION

The present invention relates to the field of solar-energy conversion systems. More specifically, the present invention relates to the field of concentrating solar-energy electrical generation systems.

### BACKGROUND OF THE INVENTION

There is a strong need for electrical generating systems utilizing renewable resources. Of the many renewable resources available, one of the most fundamental is solar energy. Many different systems for generating electricity from solar energy have been devised. All these systems suffer a common problem: economic and energy inefficiencies. These inefficiencies lead to a marked increase in electrical generation costs when compared to conventional nuclear and fossil-fuel generating systems. That is, when compared to nuclear and fossil-fuel systems, conventional solar-energy generating systems are less economically efficient because they produce relatively few kilowatt-hours per unit expenditure.

Of the various methodologies used to generate electricity from solar energy, among the most energy efficient are those that utilize solar-energy conversion (SEC) devices. SEC devices directly convert radiative solar energy (heat, light, or other radiation) into electricity. An example of a SEC device is a photovoltaic cell.

Systems utilizing SEC devices still suffer from energy inefficiency, and energy inefficiency is one factor in economic inefficiency. For a given cost, more energy efficient SEC devices lead to systems that are more economically efficient.

The most energy efficient SEC devices are concentrating SEC devices, e.g., concentrating photovoltaic cells. These devices achieve their highest efficiencies when the solar energy is highly concentrated, typically on the order of several hundred suns. This suggests the use of an optical and a mechanical structure configured to concentrate the solar energy. In order to concentrate the solar energy, an energy-gathering element of the structure (e.g., a lens or mirror) needs have an area very much larger than that of the cell. For example, a 500-sun system would require an energy-gathering element with an area 500 times the area of the cell. The energy-gathering element focuses the gathered energy onto the cell.

A tracking problem exists with concentrating SEC systems. Because the energy-gathering elements have areas very much larger than the area of the cell, the system must accurately track the position of the sun from dawn to dusk. Even a small deviation in tracking is sufficient to cause the concentrated energy to be off-target, i.e., to not be accurately centered on the cell. Only that portion of the concentrated solar energy falling on the cell is available for the generation of electricity. Energy efficiency therefore depends upon the accuracy of the tracking system.

Both the amortization of initial structure costs and the operating costs contribute to the economic efficiency in terms of kilowatt-hours per unit expenditure of the system. For systems that achieves a given level of energy efficiency, the lower cost systems will be the more economically efficient. In general, the smaller the system structure, the lower the structure and operating costs, and the greater economic efficiency in terms of kilowatt-hours per unit expenditure. Many prior art systems are larger than necessary for the solar energy gathered. That is, the systems fail to capture the amount of solar energy falling on an area equivalent to their overall array size (e.g., there are shadows, dead spots, and/or “holes” on/in the array). This results in increases in operating costs (the costs of positioning and controlling the system) and a marked decrease in economic efficiency.

Another problem facing the use of SEC devices is heat. Because of energy inefficiency, considerable heat is generated in the conversion of solar energy into electricity. This heat must be dissipated or otherwise accounted for.

Also, since no device is absolutely energy efficient, only a portion of the usable energy falling upon the cell can be converted into electricity. The remainder is converted into heat. The system must also be able to manage this generated heat.

A more energy efficient form of an SEC system is a concentrating photovoltaic system. Such a system suffers from heat in two forms. The heat inherent in concentrated sunlight may be considerable. For example, a concentrating system may produce an energy level of several hundred suns at the cell. The system must be able to manage the heat of these several hundred suns over the relatively small surface area of the cell.

Heat management is itself a process with problems of energy and economic efficiencies. One effective heat-management methodology utilizes active heat extraction. But this methodology is undesirable because, being active, it is necessary to consume power to extract heat. The power required to extract heat is effectively subtracted from the power generated by the SEC system as a whole, thereby lowering the both the energy and economic efficiencies of the system.

Some conventional high-concentrating SEC systems are high-density SEC systems. In a high-density SEC system, a large-area concentrator is used to focus solar energy in a substantially planar “focal zone.” An array of SEC devices (cells) is located in the “focal zone.” Each SEC device then receives its portion of the concentrated solar energy. The concentrator is typically made up of a plurality of lenses or mirrors, though a single large lens or mirror may be used.

There are two primary problems with high-density SEC systems: dead zones and heat. Dead zones are the necessary spaces between the active areas of the cell array, i.e., the spaces between the individual SEC cells. In absolute terms, these areas may be quite small. However, because the cells are also small and are located where the solar energy is concentrated, the dead zone can be significant. For example, in a typical array of 1-cm2 cells, the dead zone may be 1 mm wide, that means that each 1 cm² cell represents 121 mm², where 21 mm² (17.3 percent) is dead zone. This is reflected in the concentrator. In a small 1000-cell, 500-sun system, the area of the concentrator would be 60.5 m², with 10.5 m² ineffective. This does not take into account any portions of the concentrator that are inherently ineffective because of joins, seams, and/or shadow. High-density SEC system, therefore, have additional inefficiencies because of the dead zones.

High-density SEC systems also suffer from heat. The received heat can be tremendous, i.e., hundreds of suns. In addition, the generation of electricity by the SEC cells produces heat. With an efficiency of 35 percent, every kilowatt of generated electricity produces more than 1.8 kilowatts of heat. All this heat must be extracted and dissipated.

All the solar energy received by the concentrator is concentrated into a relatively small area. The removal of this heat from the relatively small area requires the use of an active heat-extraction (HE) unit. Active HE units are complex. Being complex, reliability becomes a significant design factor. To render a complex HE unit reliable is expensive. Also, active HE units require power. The power required to run the active HE unit is effectively subtracted from the power generated by the SEC system. Active HE units are therefore parasitic, and further reduce energy and economic efficiencies.

In addition, any reduction in reliability translates into an increase in operating costs in the form of increased maintenance. This increase in operating costs translates directly into a decrease in the economic efficiency of the system.

### SUMMARY OF THE INVENTION

Accordingly, it is an advantage of the present invention that a clustered solar-energy conversion array and method therefor are provided.

It is another advantage of the present invention that a solar-energy conversion array is provided that increases, to the extent reasonably practical, the percentage of received solar energy presented to the cells.

It is another advantage of the present system that a solar-energy conversion array is provided that utilizes an architecture that distributes the regions of heat concentration so that more reliable and more efficient passive heat-extraction units may be used.

It is another advantage of the present system that a solar-energy conversion array is provided with a distributed architecture to effectively reduce dead zones in areas of concentrated solar energy to the extent practical.

The above and other advantages of the present invention are carried out in one form by an array of solar-energy conversion (SEC) units for an electrical generating system. The array includes an array-support structure, and an SEC cluster. The SEC cluster includes a cell-support structure coupled to the array-support structure and N of the SEC units, wherein N is a predetermined number greater than one. Each of the SEC units includes a concave mirror coupled to the array-support structure and configured to reflect solar energy, and a cell assembly coupled to the cell-support structure. The cell assembly includes a cell housing, an SEC cell contained within the cell housing and positioned to receive a majority of the solar energy reflected by the concave mirror, and a heat-extraction unit coupled to the cell housing and configured to extract and dissipate heat from the SEC cell.

The above and other advantages of the present invention are carried out in another form by a method of converting solar energy into electricity. The method includes aiming a solar-energy conversion (SEC) array in a solar direction, reflecting solar energy from N concave mirrors in each of a plurality of SEC clusters, wherein N is a predetermined number, in response to the aiming activity, positioning one of N SEC cells relative to each of the N concave mirrors for each of the SEC clusters, receiving a majority of the solar energy reflected from each of the concave mirrors at each of the SEC cells for each of the SEC clusters in response to the reflecting and positioning activities, generating electricity in each of the SEC cells in response to the receiving activity, thermally coupling one of N heat-extraction units to each of the N SEC cells in each of the SEC clusters, and dissipating heat produced by the receiving and generating activities.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a side view of a solar-energy conversion (SEC) system in operation in accordance with a preferred embodiment of the present invention;

FIG. 2 shows a plan view of an SEC array from the SEC system of FIG. 1 depicting a tetragonal-mirror matrix in accordance with a preferred embodiment of the present invention;

FIG. 3 shows a plan view of an SEC array depicting a hexagonal-mirror matrix in accordance with an alternative preferred embodiment of the present invention;

FIG. 4 shows a plan view of an SEC cluster from the SEC array of FIG. 2 depicting mirror layout with central cell assemblies in accordance with a preferred embodiment of the present invention;

FIG. 5 shows a side view of an SEC solar-energy conversion unit from the SEC cluster of FIG. 4 in accordance with preferred embodiments of the present invention;

FIG. 6 shows a side view of an SEC unit from the SEC cluster of FIG. 4 depicting energy acquisition in accordance with a preferred embodiment of the present invention;

FIG. 7 shows a plan view of an SEC cluster depicting mirror layout with peripheral cell assemblies in accordance with an alternative preferred embodiment of the present invention;

FIG. 8 shows a side view of an SEC unit from the SEC cluster of FIG. 7 depicting energy acquisition in accordance with a preferred embodiment of the present invention;

FIG. 9 shows a side view of a cell assembly from the SEC unit of FIG. 6 demonstrating a catoptric secondary element in accordance with a preferred embodiment of the present invention;

FIG. 10 shows a side view of the cell assembly from the SEC unit of FIG. 6 demonstrating a dioptric secondary element in accordance with an alternative preferred embodiment of the present invention;

FIG. 11 shows a cross-sectional side view of a cell assembly from the SEC unit of FIG. 5 demonstrating operation of a heat-extraction unit;

FIG. 12 shows a cross-sectional side view of an SEC unit of the SEC cluster of FIG. 4 taken at line 12-12 and demonstrating a cell assembly umbral region in accordance with preferred embodiments of the present invention; and

FIG. 13 shows a cross-sectional side view of an SEC unit of the SEC cluster of FIG. 4 taken at line 13-13 and demonstrating a support arm umbral region in accordance with preferred embodiments of the present invention.

### DETAILED DESCRIPTION OF THE PREFERRED EMBODIMENTS

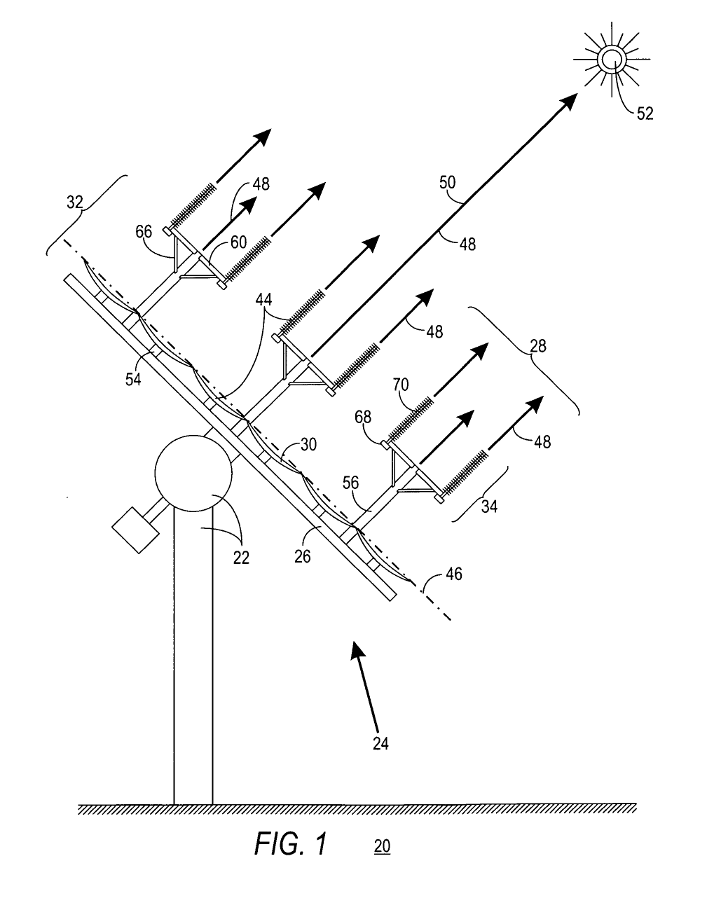

FIG. 1 shows a side view of a solar-energy conversion (SEC) system 20 in operation in accordance with a preferred embodiment of the present invention. The following discussion refers to FIG. 1.

Throughout this discussion the emphasis is on the economic efficiency of SEC system 20. While energy efficiency is concerned with the percentage of solar energy converted into electricity under a given set of conditions, economic efficiency is concerned with the number of kilowatts-hours of electricity generated per unit expenditure. Both the amortization of initial structure costs (i.e., component, construction, and installation costs) and the ongoing expenses (spare-parts, maintenance, repair, and operating costs) contribute to the economic efficiency of system 20.

It is a primary object of the present invention to increase the economic efficiency of system 20 wherever practical. It is recognized that, in many instances, a tradeoff must be made where a decrease in economic efficiency in one area is met by an increase in economic efficiency in another area. Often, the correct tradeoff is based upon the intended application and the environment in which system 20 is to be used.

SEC system 20 is made up of a system pedestal 22 and an SEC array 24. System pedestal 22 contains all components necessary to support, aim, and move SEC array 24. The components and technologies of pedestal 22 will vary according to the size of SEC array 24 and the environment in which system 20 is to be used.

By utilizing a distributed architecture (discussed hereinafter), array 24 may be made as small as is practical for the desired output. This decrease in size is reflected in a decrease in weather effects and a decrease in moment of mass. These decreases allow a smaller structure to be used for pedestal 22, which in turn lowers both the initial and operating expenses associated with pedestal 22. This increases the economic efficiency of system 20.

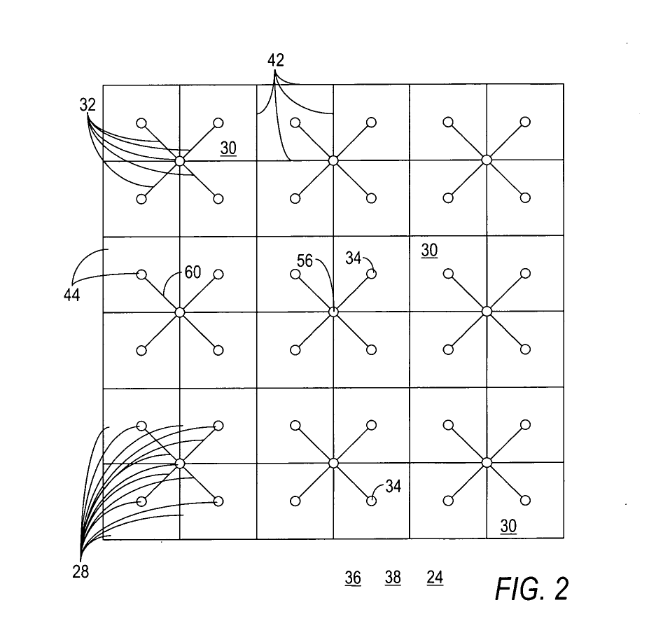

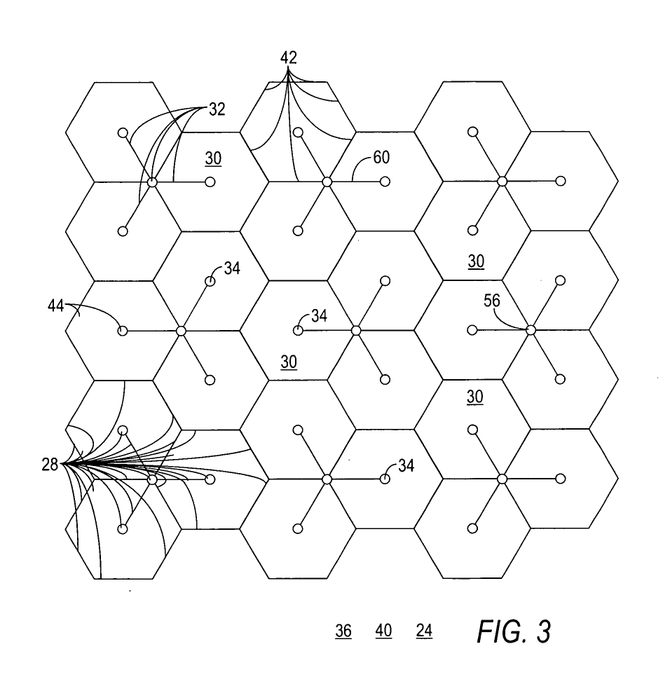

Array 24 contains an array-support structure 26 configured to support at least one SEC cluster 28. For convenience, this discussion presumes array 24 is made up of a plurality of clusters 28, specifically, nine clusters 28, as depicted in FIGS. 1, 2, and 3 (FIGS. 2 and 3 are discussed hereinafter). Those skilled in the art will appreciate, however, that the number of clusters 28 is not a requirement of the present invention. In practice, array 24 may have any number of clusters 28 from one to dozens or even hundreds, depending upon the application for which system 20 is intended.

Each SEC cluster 28 is made up of N concave mirrors 30, a cell-support structure 32, and N cell assemblies 34, where N>1. In the preferred embodiments of the Figures, 2<N<5, i.e., N=3 or N=4. This is discussed in more detail hereinafter.

FIGS. 2 and 3 show plan views of SEC array 24 depicting concave mirrors 30 forming a geometric matrix 36. FIG. 2 depicts concave mirrors 30 forming a regular tetragonal matrix 38. FIG. 3 depicts concave mirrors 30 forming a regular hexagonal matrix 40. The following discussion refers to FIGS. 1, 2, and 3.

Concave mirrors 30 are coupled to and supported by array-support structure 26 so as to form geometric matrix 36. Desirably, geometric matrix 36 is constructed of substantially identical concave mirrors 30. By being substantially identical, the fabrication of concave mirrors 30 is simplified and attendant expenses are reduced. In addition, substantially identical concave mirrors 30 mean fewer spare parts need be stocked for in-field service. The use of substantially identical concave mirrors 30 therefore increases the economic efficiency of system 20.

Desirably, each concave mirror 30 is shaped to have a substantially polygonal periphery 42, allowing a very high packing density to be achieved in geometric matrix 36. Preferably, concave mirrors 30 are shaped to be substantially regular polygons, specifically regular tetragons (squares) as in FIG. 2, or regular hexagons as in FIG. 3. As substantially regular tetragons or hexagons, concave mirrors 30 pack together so that no substantial area of geometric matrix 36 is not mirror (i.e., only small interstitial spaces 43 between adjacent concave mirrors 30 do not gather the solar energy). This allows array 24 to have a high packing density, i.e., to be as small as is reasonably possible to capture a given amount of incident solar energy. A high packing density increases the economic efficiency of system 20.

If concave mirrors 30 have substantially polygonal peripheries 42 in the shape of substantially regular tetragons (squares), then geometric matrix 36 is a regular tetragon (square) matrix 38 (FIG. 2) and N=4. Each SEC cluster 28 is then made up of four concave mirrors 30 supported by array-support structure 26, and four cell assemblies 34 supported by a single cell-support structure 32.

If concave mirrors 30 have substantially polygonal peripheries 42 in the shape of substantially regular hexagons, then geometric matrix 36 is a regular hexagonal matrix 40 (FIG. 3) and N=3. Each cluster 28 is then made up of three concave mirrors 30 supported by array-support structure 26, and three cell assemblies 34 supported by a single cell-support structure 32.

For simplicity, the remainder of this discussion will assume that concave mirrors 30 are regular tetragons, and that geometric matrix 36 is a regular tetragonal (square) matrix 38, as depicted in FIG. 2, except where FIG. 3 is specifically cited. Those skilled in the art will appreciate that the specific number (greater than one) of concave mirrors 30 in SEC cluster 28 and the specific shapes of concave mirrors 30 are not requirements of the present invention. Variant numbers of concave mirrors and variant shapes thereof may meet the requirements of specific applications. The use of variant numbers and shapes of concave mirrors 30 does not depart from the spirit of the present invention.

The following discussion refers to FIG. 1.

SEC array 24 has an array plane 46. Concave mirrors 30 are coupled to array 24 so as to be substantially parallel to array plane 46. That is, if concave mirrors were flat, they would define array plane 46.

Array 24 has an aim direction 48 that is perpendicular to array plane 46. Aim direction 48 is the direction from which array 24 would most efficiently receive the solar energy with which system 20 would generate electricity. Therefore, to be operational, array 24 is desirably aimed in a solar direction 50, where solar direction 50 is defined as the mean direction of the sun 52. That is, aim direction 48 is desirably substantially coincident with solar direction 50 for system 20 to be effective in converting solar energy into electricity.

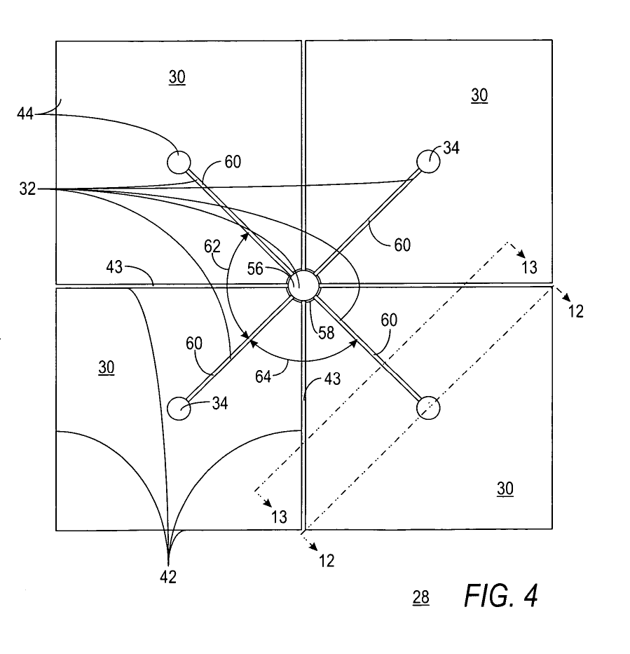

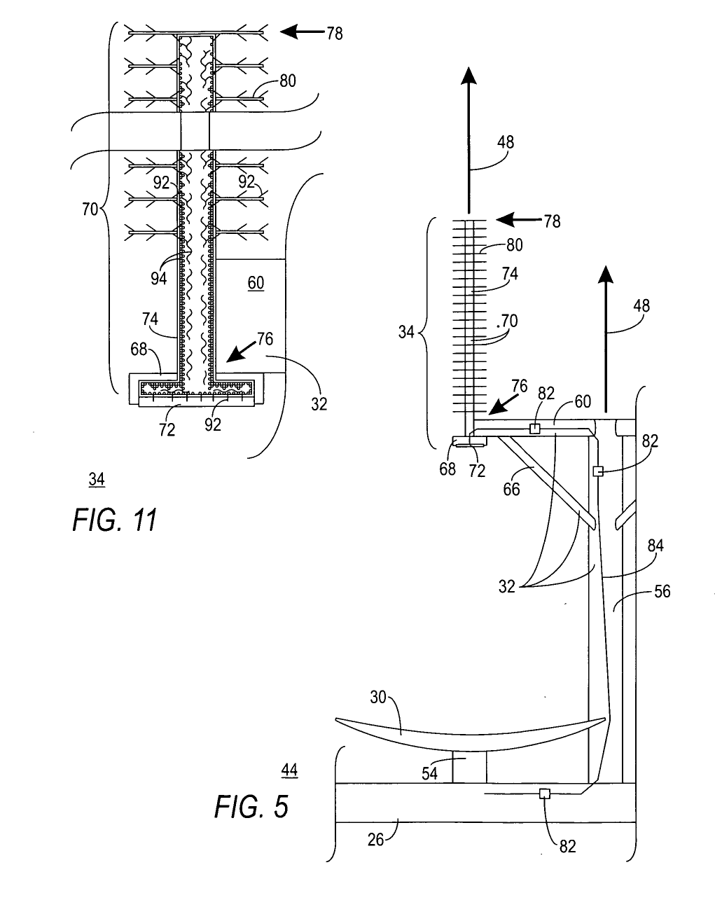

FIG. 4 shows a plan view of SEC cluster 28 depicting four concave mirrors 30 and cell assemblies 34, and FIG. 5 shows a side view of an SEC unit 44 from SEC cluster 28. The following discussion refers to FIGS. 1, 4, and 5.

Within each SEC cluster 28 of array 24, the N concave mirrors 30 are coupled to and supported by array-support structure 26. In the preferred embodiments shown in the Figures, each concave mirror 30 is coupled to array-support structure 26 by a support pad 54. Support pad 54 may be affixed to concave mirror 30 by an adhesive (not shown), by a bolt or other fastener (not shown), or by other means well known to those skilled in the art. Those skilled in the art will appreciate that support pad 54 is exemplary and not a requirement of the present invention. The use of other methodologies for the coupling and support of concave mirror 30 (e.g., periphery clips) does not depart from the spirit of the present invention.

Support pad 54 may be adjustable. That is, support pad 54 may be coupled to either concave mirror 30 or array-support structure 26 so that adjustments of support pad 54 will “rock” concave mirror 30 slightly relative to array plane 46. By adjusting support pad 54, concave mirror 30 may be fine tuned to compensate for minor aberrations in the positioning of cell assembly 34 and more accurately reflect the solar energy onto the associated cell (discussed hereinafter).

Each SEC cluster 28 includes cell-support structure 32. Each cell-support structure 32 is made up of a support column 56 coupled to and supported by array-support structure 26, and extending between and accommodated by a common juncture of adjacent concave mirrors 30 in aim direction 48.

In order for support column 56 to extend between adjacent concave mirrors 30 in the preferred embodiments of the Figures, while at the same time allowing concave mirrors 30 to form geometric matrix 36 with the highest practical density, the substantially polygonal peripheries 42 are notched. That is, a notch 58 is introduced into polygonal periphery 42 of at least one concave mirror 30 in each cluster 28 to accommodate support column 56. In the preferred embodiment of FIG. 4, notch 58 is taken from the substantially (i.e., notched) polygonal periphery 42 at the common corner of each concave mirror 30 in cluster 28. Since reflections of the solar energy from the corners of concave mirror 30 are the most likely to suffer off-target aberrations, notching the common corners of concave mirrors 30 in cluster 28 (as contrasted to non-corner portions of substantially polygonal periphery 42) produces the least objectionable decrease in the economic efficiency of system 20.

Those skilled in the art will appreciate that notches 58 may be eliminated in alternative embodiments not shown in the Figures. In one such alternative embodiment, support column 56 may be structured to not have an enclosed interior. For example, support column 56 may have a cruciform cross-section parallel to array plane 46, with the “arms” of this cruciform shape lying entirely within interstitial spaces 43 at the common juncture of concave mirrors 30 of cluster 28. In a variant of this alternative embodiment, support column 56 may have an outer covering over that portion of support column 56 located sunward of concave mirrors 30. These and other alternative embodiments of support column 56 may be used without departing from the spirit of the present invention.

Each SEC cluster 28 includes N cell assemblies 34, with each cell assembly 34 coupled to support column 56 and supported by a support arm 60. Support arm 60 extends from support column 56 to cell assembly 34.

In the preferred embodiments, wherein concave mirrors 30 have peripheries 42 that are substantially (i.e., notched) regular polygons, any given support arm 60 in each cluster 28 makes a first angle 62 with a clockwise adjacent support arm 60, and a substantially equal second angle 64 with a counterclockwise adjacent support arm 60. That is, regardless of the value of N, support arms 60 are regularly angularly spaced about support column 56. In FIGS. 2 and 4, where N=4, the angles between support arms 60 (i.e., first and second angles 62 and 64) are 90°. In FIG. 3, where N=3, the angles between support arms 60 (i.e., first and second angles 62 and 64) are 120°.

In the preferred embodiment of FIG. 5, support arm 60 and cell assembly 34 are further stabilized and supported by a support brace 66. In FIG. 5, support brace 66 is shown as beneath support arm 60 and extending from support column 56 to support arm 60. Those skilled in the art will appreciate that the existence, position, and coupling of support brace 66 are not requirements of the present invention. Support brace 66 may be omitted, or, when used, may be either above or below support arm 60 and/or extend to either support arm 60 or cell assembly 34 without departing from the spirit of the present invention.

Each cell assembly 34 is positioned relative to and associated with one concave mirror 30. Each cell assembly 34 and its associated concave mirror 30 together make up SEC unit 44. Cluster 28 is therefore made up of N SEC units 44, i.e., of N cell assemblies 34 and N associated concave mirrors 30. Since array 24 is an array of clusters 28, array 24 is also an array of SEC units 44.

SEC units 44 are separate entities. That is each SEC unit 44 is made up of concave mirror 30 and an associated cell assembly 34. Cell assemblies 34 are positioned over their respective concave mirrors 30, and therefore are evenly distributed over an area only slightly smaller than array 24. Each cell assembly 34 is made up of a cell housing 68 coupled to a heat-extraction (HE) unit 70. An SEC cell 72 is contained within cell housing 68. Each concave mirror 30 is configured to reflect and concentrate solar energy onto only its associated cell 72. The heat produced at each cell 72 is extracted and dissipated by a separate HE unit 70. This constitutes a distributed approach, wherein the total heat is extracted and dissipated over an area only slightly smaller than array 24. This is in marked contrast to a prior-art high-density SEC system wherein the total heat is extracted and dissipated in a single relatively small area. This distributed architecture presents a significant increase in the economic efficiency of system 20.

One device suitable for use as SEC cell 72 in system 20 is the Multi-Junction Terrestrial Concentrator Solar Cell, manufactured by Spectrolab, Inc. Those skilled in the art will appreciate, however, that the use of this device as SEC cell 72 is not a requirement of the present invention, and that other devices by this and other manufacturers may be used without departing from the spirit of the present invention.

HE unit 70 is made up of a heat pipe 74 having an extraction end 76 and a dissipation end 78. Heat pipe 74 is coupled to cell housing 68. Extraction end 76 of heat pipe 74 is thermally coupled to SEC cell 72 and configured to extract heat therefrom. At least one radiator 80, and preferably a plurality of radiators 80, is coupled to heat pipe 74. Radiators 80 are configured to dissipate heat. Therefore at least one radiator 80 is desirably coupled at or near dissipation end 78 of heat pipe 74.

Electrically, cell assembly 34 also includes a bypass diode 82. Bypass diode 82 is located outside of cell housing 68. This location for bypass diode 82 allows cell housing 68 to be made smaller than would otherwise be possible were bypass diode 82 to be located inside cell housing 68. As discussed hereinafter, it is desirable that cell housing 68 be as small as possible in order to cast as small a shadow as is reasonably possible upon concave mirror 30. The reduction in size of cell housing 68 therefore represents an increase in the economic efficiency of system 20.

Bypass diode 82 is desirably located within support arm 60, within support column 56, or within or upon array-support structure 26 so that it contributes to no shadow cast on concave mirror 30. Bypass diode 82 is electrically coupled to cell 72 by wires 84.

Each concave mirror 30 is configured to reflect and concentrate solar energy onto its associated cell 72. This solar energy may reach hundreds of suns in intensity. When array 24 is not aimed directly at the sun 52, i.e., when aim direction 48 is not coincident with solar direction 50, this concentrated solar energy may play upon support arm 60 and/or support column 56. The concentrated solar energy has the potential to damage wires 84 if exposed. Therefore, portions of wires 84 in danger of such damage are desirably insulated and routed within support arms 60 and support column 56.

The remainder of this discussion presumes SEC system 20 to be in operation, i.e., that aim direction 48 is substantially coincident with solar direction 50. For the sake of simplicity, the remainder of this discussion discusses the operation of a single SEC unit 44. All SEC units 44 in array 24 operate substantially identically.

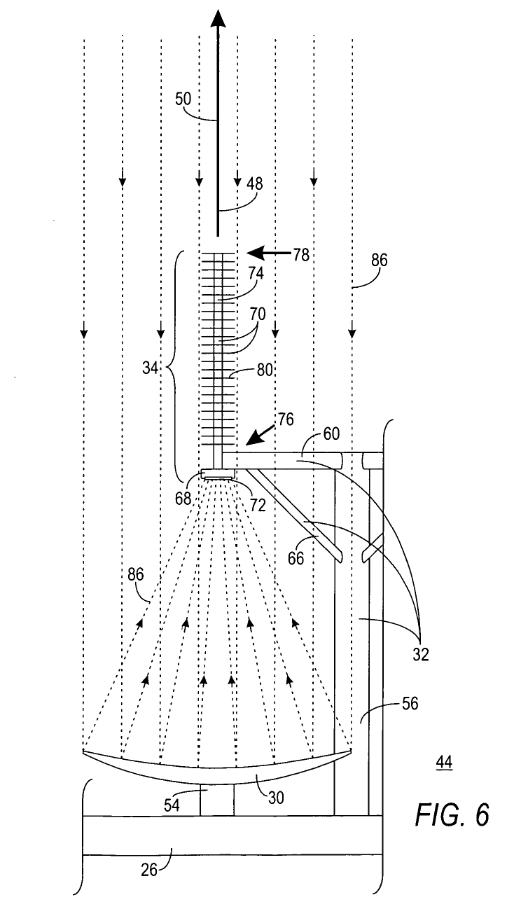

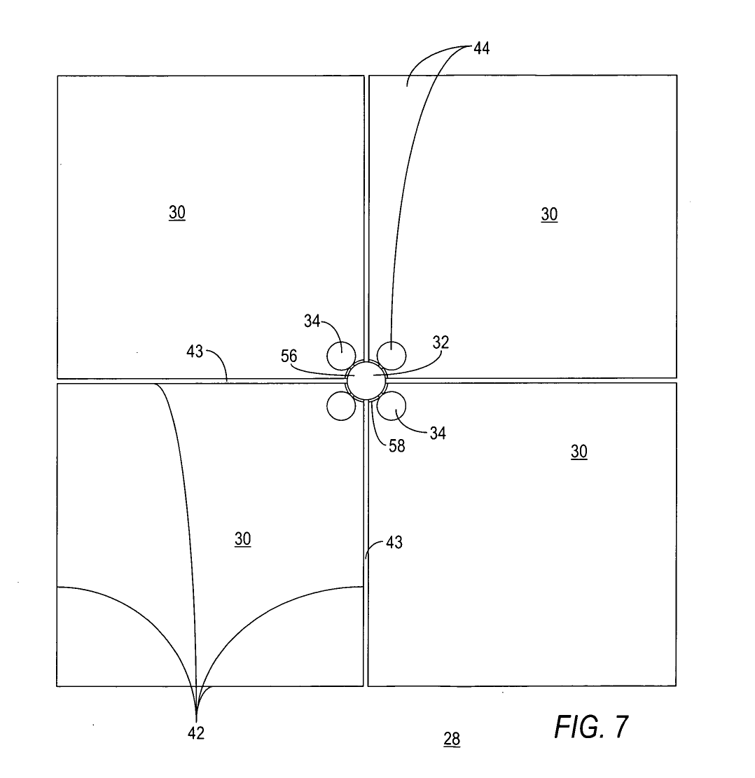

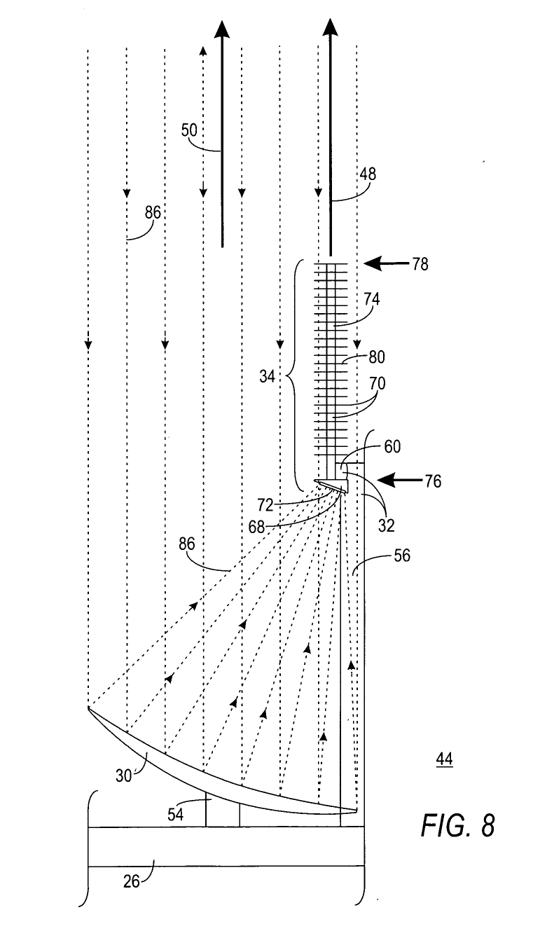

FIGS. 4 and 7 show plan views of SEC cluster 28 with cell assemblies 34 centrally (FIG. 4) and peripherally (FIG. 7) located relative to concave mirrors 30, and FIGS. 6 and 8 show side views of SEC units 44 from the clusters 28 of FIG. 4 and FIG. 7, respectively, depicting acquisition of solar energy 86. The following discussion refers to FIGS. 1, 4, 6, 7, and 8.

Solar energy 86 proceeds in a direction inverse to solar direction 50 until it encounters concave mirror 30. Concave mirror 30 is the primary optical element of SEC unit 44. Concave mirror 30 reflects and concentrates solar energy 86. SEC cell 72 is positioned proximate a “focal point” of concave mirror 30.

In the preferred embodiment of FIGS. 4 and 6, concave mirror 30 is oriented so that the “focal point” is in aim direction 48 from a center of concave mirror 30. SEC cell 72 is therefore also located in aim direction 48 from the center of concave mirror 30. In this embodiment, concave mirror 30 is symmetrically formed and symmetrically mounted. This provides the lowest initial costs for concave mirror 30 and support pad 54.

In the alternative preferred embodiment of FIGS. 7 and 8, concave mirror 30 is angled so that the “focal point” is located over the periphery of concave mirror 30 proximate support column 56. SEC cell 72 is therefore also located proximate support column 56 and angled to be planar relative to concave mirror 30. In this embodiment, concave mirror 30 is asymmetrically formed and asymmetrically mounted. This may require greater initial costs for concave mirror 30 and support pad 54. While this may result in some decrease in the economic efficiency of system 20, any decrease in the economic efficiency is offset, at least in part, by the casting of a smaller shadow (discussed hereinafter) upon concave mirror 30. Casting a smaller shadow increases the surface area of concave mirror 30 that reflects solar energy 86, and this increases the economic efficiency of system 20.

Whether it is better to symmetrically or asymmetrically form and mount concave mirror 30 is a matter of tradeoffs, wherein one embodiment may be preferable for some applications and environments, while the other embodiment may be preferable for differing applications and embodiments. For the sake of simplicity, the remainder of this discussion presumes the preferred embodiment of FIGS. 4 and 6 except where FIGS. 7 and 8 are specifically referenced.

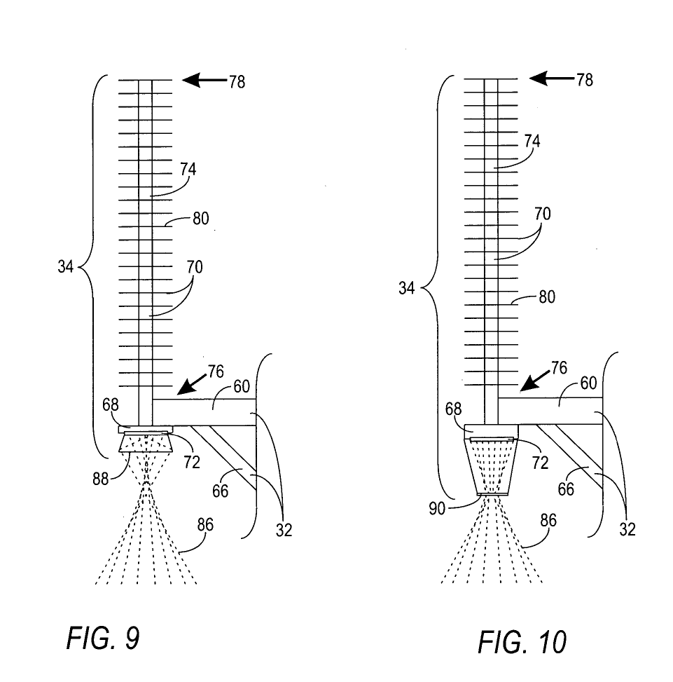

FIGS. 9 and 10 show side views of cell assembly 34 demonstrating a catoptric secondary optical element 88 (FIG. 9) and a dioptric secondary optical element 90 (FIG. 10). The following discussion refers to FIGS. 1, 4, 6, 9, and 10.

If, for the sake of discussion, the sun 52 is treated as a point, then solar energy 86 may be treated as substantially parallel rays. If concave mirror 30 were parabolic, then the reflected solar energy 86 would converge at a true focal point on an optical axis (not shown) of concave mirror 30. SEC cell 72 would then be positioned ahead of or behind the focal point along the optical axis at a position where solar energy 86 forms an “image” substantially the size of cell 72. This is especially effective when concave mirror 30 has a polygonal periphery 42 that is substantially a regular tetragon and effectively matches the shape of cell 72.

Forming concave mirror 30 to a parabola can increase the costs associated therewith, however, and result in a decrease in the economic efficiency of system 20. Because of this, concave mirror 30 may, in many embodiments, be desirably a spherical mirror. If concave mirror 30 were spherical, then the reflected solar energy 86 would converge at a “focal point” that is spread along the optical axis. This is known as spherical aberration. The spherical aberration may make it practically impossible to successfully position SEC cell 72. That is, any position along the optical axis would produce either marked hot and/or cold spots, with an attendant loss of light and a decrease in the economic efficiency of system 20, and potential damage to cell 72.

A secondary optical element may be used to compensate for the spherical or other aberration of concave mirror 30. In FIG. 9, catoptric (reflective) secondary optical element 88 is used to better reflect solar energy 86 that would otherwise be lost onto cell 72. Similarly, in FIG. 10, dioptric (lensatic) secondary optical element 90 serves a similar function of directing the maximum practical amount of solar energy 86 onto cell 72. Either catoptric or dioptric element 88 or 90 may be used, but again there are tradeoffs. Catoptric element 88, being reflective, suffers less optical loss, but may be more expensive to fabricate and maintain. Dioptric element 90, being lensatic, suffers greater optical loss (through reflection and absorption), but may be cheaper to fabricate and maintain. Catoptric and dioptric elements 88 and 90 each present a differing decrease in the economic efficiency of system 20 over no secondary optical element at all, but whether or which of these decrease in economic efficiency is offset by the increase in economic efficiency produced by the use of a spherical concave mirror 30 is problematic. As with all tradeoffs, which combination of parabolic or spherical concave mirror 30 and/or no secondary element, catoptric element 88 or dioptric element 90 is most desirable is a function of the application and environment in which system 20 is to be used.

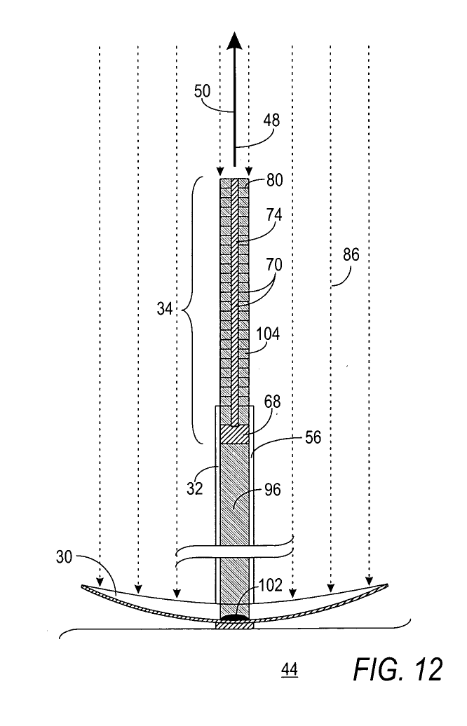

FIG. 11 shows a cross-sectional side view of cell assembly 34 demonstrating operation of HE unit 70. The following discussion refers to FIGS. 1, 4, 6, and 11.

Concave mirror 30 reflects and concentrates solar energy 86. SEC cell 72 is positioned to receive a majority of the solar energy 86 reflected and concentrated by concave mirror 30. SEC cell 72 then generates electricity (not shown) in response to the reception of solar energy 86.

Solar energy 86 is transferred into cell 72 during the reception of solar energy 86. Any energy not converted into electricity is a source of heat. The result is that cell 72 accumulates a significant amount of heat, which must be removed to maintain the maximum energy efficiency for cell 72 reasonably possible and to prevent the destruction of cell 72. HE unit 70 accomplishes this task.

As discussed hereinbefore, the distributed architecture of array 24 spreads SEC cells 72 over an area only slightly smaller than array 24. Each concave mirror 30 is configured to reflect and concentrate solar energy 86 onto only its associated cell 72. The heat produced at each cell 72 is extracted and dissipated by a separate HE unit 70. The more modest heat extraction demands of the separate cells 72 of the present invention allow the use of more modest heat-extracting units.

HE unit 70 is a passive HE unit. That is, the operations within HE unit 70 are purely thermodynamic, utilizing solely the heat extracted from cell 72. Since this heat is waste energy not usable by system 20 to generate electricity, HE unit 70 has no overhead, and does not affect ongoing economic efficiency of system 20. In addition to being passive, HE unit 70 has no moving parts save a liquid thermal transfer medium (discussed hereinafter). This inherent simplicity provides HE unit 70 with a reliability well above and beyond any active heat-extraction unit. The absence of overhead and the simplicity of HE units 70 result in a marked increase in the economic efficiency of system 20 over prior-art high-density SEC system of similar capacity.

Extraction end 76 of heat pipe 74 is thermally coupled to cell 72. Heat 92 from cell 72 therefore enters heat pipe 74. A normally liquid thermal transfer medium 94 is located within heat pipe 74. Thermal transfer medium 94 absorbs heat 92. Heat 92 vaporizes thermal transfer medium 94. Vaporized thermal transfer medium 94 is depicted in FIG. 11 as tiny bubbles along the inside wall of heat pipe 74.

When system 20 is in operation, dissipation end 78 of heat pipe 74 is higher than extraction end 76. Since heat rises (and gasses tend to rise in liquids), the hotter, vaporized thermal transfer medium 94 migrates towards dissipation end 78 of heat pipe 74. During migration, the vaporized thermal transfer medium 94 passes or approaches at least one radiator 80, desirably a plurality of radiators 80. Heat 92 is transferred from thermal transfer medium 94 into radiator(s) 80. Radiators 80 dissipate heat 92.

The transfer of heat 92 from thermal transfer medium 94 into radiator(s) 80 lowers the temperature of thermal transfer medium 94. This causes thermal transfer medium 94 to condense back into liquid form. Thermal transfer medium 94 then returns to extraction end 76 of heat pipe 74 by means of gravity.

HE unit 70 therefore extracts and dissipates heat 92 produced in cell 72 by the reception of solar energy 86 and the generation of electricity (not shown).

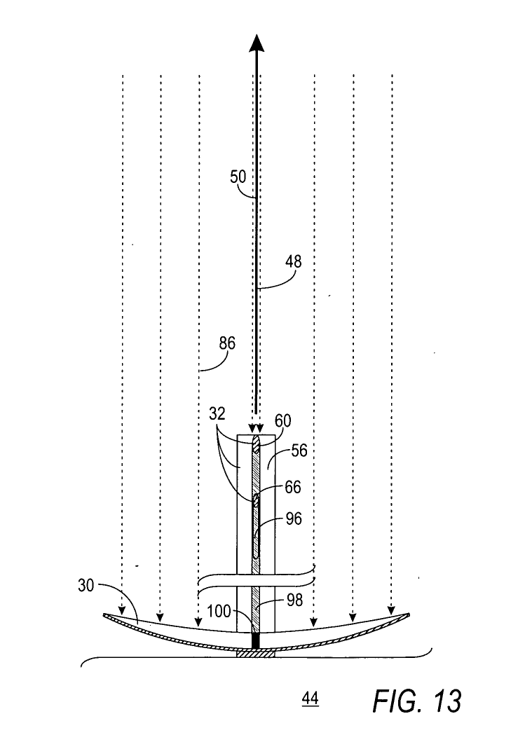

FIGS. 12 and 13 show cross-sectional side views of SEC unit 44 taken at lines 12-12 and 13-13 of FIG. 4, respectively, and demonstrating a cell-housing umbral region 96 (FIG. 12) and a support-arm umbral region 98 (FIG. 13). The following discussion refers to FIGS. 1, 4, 5, 12, and 13.

Solar energy 86 may be thought of as substantially parallel rays arriving at array 24 from an inverse of solar direction 50, i.e., from the sun 52. When SEC system 20 is in operation, i.e., when aim direction 48 is substantially equal to solar direction 50, anything sunward of array plane 46 may potentially cast shadows upon concave mirrors 30. Any shadows that fall upon a concave mirror 30 produces a decrease in energy output. Since it is always desirable to increase, to the extent reasonably practical, energy output for a given size of array 24, it is desirable that all shadows falling upon concave mirror 30 be kept to a practical minimum. In the present invention, this is accomplished through the design and arrangement of components.

Support column 56 extends in aim direction 48 from array-support structure 26 between adjacent concave mirrors 30 and terminates sunward of array plane 46. Desirably, support column 56 is a cylinder (shown), a prism (not shown), or other shape (not shown) having substantially smooth sides parallel to aim direction 48. Since aim direction 48 is substantially coincident with solar direction 50, and since support column 56 passes though notches 58 in concave mirrors 30 (FIG. 4), support column 56 casts a shadow that falls only behind concave mirrors 30. In the preferred embodiments of the Figures, the shadow of support column 56 is accommodated by periphery notch 58 (FIG. 2). That is, support column 56 cast a support-column shadow (not shown) that falls upon none of concave mirrors 30.

Support arms 60 and support braces 66 extend from support column 56 to cell assembly 34. In the preferred embodiment, each support arm 60 and any attendant support brace 66 together produce a support-arm umbral region 98 extending from an upper one of support arm 60 and support brace 66, is potentially modified by a lower one of support arm 60 and support brace 66, and falls upon only that concave mirror 30 directly below that support arm 60. That is, any given support arm 60 and its attendant support brace 66 together cast a support-arm shadow 100 upon only one of concave mirrors 30.

In the preferred embodiment of FIGS. 1, 5, and 13, support arm 60 is sunward of support brace 66. Support brace 66 has an infinity of potential diameters (not shown) parallel to array plane 46 that are not greater than the corresponding diameters of support arm 60. Support-arm umbral region 98, created by the blockage of solar energy 86 at support arm 60, entirely encompasses support brace 66. Support brace 66 therefore contributes nothing to support-arm shadow 100 upon concave mirror 30. Support-arm shadow 100, as cast by support arm 60 and support brace 66 together, is therefore no greater than support-arm shadow 100 would be if cast by support arm 60 absent support brace 66.

It is desirable to reduce as much as possible the amount of shadow falling upon concave mirrors 30. For this reason, it is most desirable that support arm 60 extend only from support column 56 to cell assembly 34. If support arm 60 were to extend beyond cell assembly 34, e.g., across concave mirror 30 to an opposite corner or side, then the extension of support arm 60 would cast additional shadow upon concave mirror 30 and would thereby decrease the economic efficiency of system 20.

Referring briefly to FIGS. 7 and 8 (for this paragraph only), it may be seen that peripherally positioning cell assemblies 34 would reduce or even eliminate support-arm shadow 100. While this will produce a desirable increase in the economic efficiency of system 20, that increase in economic efficiency may be offset by an increase in the costs of concave mirror 30. Again, the tradeoffs are dependent upon the application and environment in which system 20 is to be used.

Each cell assembly 34, being sunward of its associated concave mirror 30, casts a cell-assembly shadow 102 upon only that one concave mirror 30. Cell assembly 34 is made up of cell housing 68 and HE unit 70. HE unit 70 extends from cell housing 68 in aim direction 48. Desirably, no diameter parallel to array plane 46 of any portion of HE unit 70 is greater than the corresponding diameter of cell housing 68.

Desirably, an HE-unit umbral region 104, created by the blockage of solar energy 86 by the collective components of HE unit 70, falls completely upon cell housing 68. Cell-housing umbral region 96, created by the blockage of solar energy 86 by the combination of the collective components of HE unit 70 and by cell housing 68, falls upon concave mirror 30 to produce cell-assembly shadow 102. HE unit 70 therefore contributes nothing to cell-assembly shadow 102 upon concave mirror 30. Cell-assembly shadow 102, as cast by cell housing 68 and HE unit 70 together, is therefore no greater than cell-assembly shadow 102 would be if cast by cell housing 68 absent HE unit 70.

In summary, the present invention teaches a clustered solar-energy conversion array 24 and method therefor. Array 24 increases, to the extent reasonably practical, the percentage of received solar energy 86 presented to cells 72. A distributed architecture is utilized that allows the use of a reliable and efficient passive heat-extraction unit 70, and effectively eliminates dead zones between cells 72.

Although the preferred embodiments of the invention have been illustrated and described in detail, it will be readily apparent to those skilled in the art that various modifications may be made therein without departing from the spirit of the invention or from the scope of the appended claims.

What is claimed is:

1. An array of solar-energy conversion (SEC) units for an electrical generating system, said array comprising:
an array-support structure; and
an SEC cluster, wherein said SEC cluster includes a cell-support structure coupled to said array-support structure and N of said SEC units, wherein N is a predetermined number greater than one, and wherein each of said SEC units includes:
a concave mirror coupled to said array-support structure and configured to reflect solar energy; and
a cell assembly coupled to said cell-support structure, wherein said cell assembly includes:
a cell housing;
an SEC cell contained within said cell housing and positioned to receive a majority of said solar energy reflected by said concave mirror; and
a heat-extraction dissipation (HE) unit coupled to said cell housing and configured to dissipate heat from said SEC cell.

2. An array as claimed in claim 1 wherein said SEC cluster is one of a plurality of SEC clusters.

3. An array as claimed in claim 1 wherein N is greater than two and less than five.

4. An array as claimed in claim 1 wherein each of said concave mirrors has a substantially polygonal periphery in the shape of one of a tetragon and a hexagon.

5. An array as claimed in claim 4 wherein said polygonal periphery of one of said concave mirrors has a notch configured to accommodate said cell-support structure.

6. An array as claimed in claim 1 wherein said cell-support structure comprises:
a support column coupled to said array-support structure and extending between adjacent ones of said concave mirrors in substantially an aim direction; and
N support arms coupled to said support column, wherein each of said N support arms extends from said support column to one of said N cell assemblies.

7. An array as claimed in claim 6 wherein, for each of said support arms, a first angle between said each support arm and a clockwise adjacent support arm is substantially equal to a second angle between said each support arm and a counterclockwise adjacent support arm.

8. An array as claimed in claim 6 wherein each of said N support arms extends only from said support column to said one cell assembly.

9. An array as claimed in claim 6 wherein, when said aim direction is a solar direction:
said support column casts a support-column shadow upon none of said concave mirrors; and
each of said support arms casts a support-arm shadow upon only one of said concave mirrors.

10. An array as claimed in claim 9 wherein said cell-support structure additionally comprises a support brace for said each support arm.

11. An array as claimed in claim 10 wherein:
said support arm and said support brace together cast said support-arm shadow upon said one concave mirror; and
said support-arm shadow, when cast by said support arm and support brace together, is not greater than said support-arm shadow if cast by said support arm absent said support brace.

12. An array as claimed in claim 6 wherein a common juncture between said concave mirrors in said SEC cluster accommodates said support column.

13. An array as claimed in claim 1 having an aim direction, and wherein, when said aim direction is a solar direction:
each of said cell assemblies casts a cell-assembly shadow upon only one of said concave mirrors; and
said cell-assembly shadow, when cast by said cell housing and said HE unit together, is not greater than said cell-assembly shadow if cast by said cell housing absent said HE unit.

14. An array as claimed in claim 1 wherein said cell assembly additionally comprises a bypass diode located outside of said cell housing.

15. An array as claimed in claim 14 wherein said bypass diode does not contribute to any shadow upon any of said concave mirrors.

16. An array as claimed in claim 14 wherein:
said bypass diode is electrically coupled to said SEC cell by wires; and
a portion of said wires are routed within a portion of said cell-support structure.

17. An array as claimed in claim 1 wherein said HE unit is a passive HE unit.

18. An array as claimed in claim 1 wherein said HE unit comprises:
a heat pipe having an extraction end, having a dissipation end higher than said extraction end, and configured to extract heat from said SEC cell proximate said extraction end; and
a radiator coupled to said heat pipe and configured to dissipate said heat.

19. An array as claimed in claim 18 wherein said heat pipe comprises a thermal transfer medium configured to:
absorb heat from said SEC cell proximate said extraction end;
vaporize in response to said absorption of heat;
migrate towards said dissipation end;
transfer said heat into said radiator;
condense in response to said transfer of heat; and
return to said extraction end in response to gravity.

20. A method of converting solar energy into electricity, said method comprising:
aiming a solar-energy conversion (SEC) array in a solar direction;
reflecting said solar energy from N concave mirrors in each of a plurality of SEC clusters, wherein N is a predetermined number, in response to said aiming activity;
positioning one of N SEC cells relative to each of said N concave mirrors for each of said SEC clusters;
receiving a majority of said solar energy reflected from each of said N concave mirrors at each of said N SEC cells for each of said SEC clusters in response to said reflecting and positioning activities;
generating said electricity in each of said N SEC cells in each of said SEC clusters in response to said receiving activity;
thermally coupling one of N heat-extraction (HE) units to each of said N SEC cells in each of said SEC clusters; and
dissipating heat produced by said receiving and generating activities.

21. A method as claimed in claim 20 additionally comprising:
coupling a cell-support structure to an array-support structure for each of said SEC clusters;
coupling said N concave mirrors to said array-support structure for each of said SEC clusters;
containing each of said N SEC cells within one of N cell housings for each of said SEC clusters;
coupling each of said N HE units to one of said N cell housings; and
coupling one of said N cell housings and said N HE units to said cell-support structure.

22. A method as claimed in claim 20 wherein N is greater than 2 and less than 5.

23. A method as claimed in claim 20 additionally comprising shaping each of said concave mirrors in each of said SEC clusters to have a substantially polygonal periphery.

24. A method as claimed in claim 23 additionally comprising:
extending a support column of said cell-support structure from an array-support structure and between adjacent ones of said concave mirrors in an aim direction; and
extending each of N support arms from said support column to one of N cell assemblies.

25. A method as claimed in claim 20 wherein, for each of said N SEC cells for each of said SEC clusters, said dissipating activity comprises:
absorbing heat from said SEC cell at an extraction end of a heat pipe of said HE unit;
vaporizing a thermal transfer medium within said heat pipe in response to said absorbing activity;
migrating said thermal transfer medium towards a dissipation end of said heat pipe, said dissipation end being higher than said extraction end;
transferring said heat into a radiator coupled to said heat pipe;
condensing said thermal transfer medium in response to said transferring activity;
returning said thermal transfer medium to said extraction end in response to gravity; and
dissipating said heat from said radiator.

26. A solar-energy conversion (SEC) array comprising:
an aim direction substantially coincident with a solar direction when said array is operational;
an array-support structure; and
a plurality of SEC clusters, wherein each of said SEC clusters comprises:
N of SEC units, wherein N is a predetermined number greater than two and less than five, and wherein each of said N SEC units comprises:
a concave mirror coupled to said array-support structure, configured to reflect solar energy when said array is operational, and having a substantially polygonal periphery;
a cell assembly configured to cast a cell-assembly shadow upon only one of said concave mirrors when said array is operational, and comprising:
a cell housing;
an SEC cell contained within said cell housing and positioned to receive a majority of said solar energy reflected by said concave mirror when said array is operational; and
a passive heat-extraction (HE) unit coupled to said cell housing and comprising:
a heat pipe coupled to said SEC cell and configured to extract heat therefrom; and
a radiator coupled to said heat pipe and configured to dissipate said heat; and
a cell-support structure comprising;
a support column coupled to said array-support structure, extending in substantially said aim direction, and configured to cast a support-column shadow upon none of said concave mirrors when said array is operational; and
N support arms coupled to said support column, wherein each of said N support arms extends from said support column to one of said cell assemblies, and is configured to cast an support-arm shadow upon only one of said concave mirrors when said array is operational.

27. An SEC array as claimed in claim 26 wherein said cell-support structure additionally comprises N support braces, wherein:
each of said N support braces is coupled between said support column and one of said N support arms; and
when said array is operational, said support-arm shadow is cast by said each support arm and said support brace coupled thereto, and is not greater than said support-arm shadow if cast by said each support arm absent said support brace.

28. An SEC array as claimed in claim 26 wherein, when said array is operational, said cell-assembly shadow is cast by said cell housing and said HE unit coupled thereto, and is not greater than said cell-assembly shadow if cast by said cell housing absent said HE unit.
